(19) United States
(12) Patent Application Publication
(10) Pub. No.: US 2013/0264520 A1
(43) Pub. Date: Oct. 10, 2013

(54) CATALYST COMPRISING PHYSICALLY AND CHEMICALLY BLOCKED ACTIVE PARTICLES ON A SUPPORT

(71) Applicants: Pascal Del-Gallo, Dourdan (FR); Fabrice Rossignol, Verneuil Sur Vienne (FR); Thierry Chartier, Feytiat (FR); Raphael Faure, Villebon-Sur-Yvette (FR); Claire Bonhomme, Panazol (FR); Sebastien Goudalle, Limoges (FR)

(72) Inventors: Pascal Del-Gallo, Dourdan (FR); Fabrice Rossignol, Verneuil Sur Vienne (FR); Thierry Chartier, Feytiat (FR); Raphael Faure, Villebon-Sur-Yvette (FR); Claire Bonhomme, Panazol (FR); Sebastien Goudalle, Limoges (FR)

(73) Assignees: L'Air Liquide Societe Anonyme Pour L'Etide Et L'Exploitation Des Procedes Georges Claude, Paris (FR); Centre National De La Recherche Scientifique- France, Paris Cedex 16 (FR); Universite De Limoges, Limoges Cedex (FR)

(21) Appl. No.: 13/994,498

(22) PCT Filed: Dec. 14, 2011
(86) PCT No.: PCT/FR2011/052975

§ 371 Date: Jun. 14, 2013

(30) Foreign Application Priority Data
Dec. 16, 2010 (FR) 1060634

(51) Int. Cl. B01J 23/58

(52) U.S. Cl. CPC B01J 23/58
USPC 252/373; 502/300; 502/325; 502/328

(57) ABSTRACT

The invention relates to a catalyst comprising: a) a catalyst support made of a ceramic, the support comprising an arrangement of crystallites having the same size, the same isodiametric morphology and the same chemical composition or substantially the same size, the same isodiametric morphology and the same chemical composition, in which each crystallite makes point contact or almost point contact with the surrounding crystallites; and b) at least one active phase comprising metallic particles that interact chemically with said catalyst support made of a ceramic and that are mechanically anchored to said catalyst support in such a way that the coalescence and mobility of each particle are limited to a maximum volume corresponding to that of a crystallite of said catalyst support.

The present invention relates to a catalyst comprising active particles physically and chemically fixed on the catalyst support.

Heterogeneous catalysis is vital to numerous applications in the chemical, food, pharmaceutical, automotive, and petrochemical industries.

A catalyst is a material which converts reactants to product through repeated and uninterrupted cycles of unit phases. The catalyst participates in the conversion, returning to its original state at the end of each cycle throughout its lifetime. A catalyst modifies the reaction kinetics without changing the thermodynamics of the reaction.

In order to maximize the degree of conversion of supported catalysts it is essential to maximize the accessibility of the active particles for the reactants. For the purpose of understanding the advantage of a catalyst such as that presently claimed, the principal steps in a heterogeneously catalyzed reaction will first be recalled. A gas composed of molecules A passes through a catalyst bed and reacts at the surface of the catalyst to form a gas of species B. Collectively, the unit steps are as follows:

a) transport of reactant A (volume diffusion), through a layer of gas to the outer surface of the catalyst

b) diffusion of species A (volume diffusion or molecular (Knudsen) diffusion) through the pore network of the catalyst to the catalytic surface

c) adsorption of species A on the catalytic surface

d) reaction of A to form B at the catalytic sites present on the surface of the catalyst

e) desorption of product B from the surface

f) diffusion of species B through the pore network

g) transport of product B (volume diffusion) from the outer surface of the catalyst through the layer of gas to the gas flow.

The catalysts used in the process of steam reforming of methane are subject to extreme operating conditions: a pressure of approximately 30 bar and a temperature ranging from 600° C. to 900° C., in an atmosphere containing primarily the gases CH₄, CO, CO₂, H₂, and H₂O.

The main problem encountered in the use of catalysts for the reforming of methane nowadays concerns the coalescence of the metal particles which constitute the active sites. This coalescence leads to a drastic reduction in the metal surface area available for the chemical reaction and this is manifested in reduced catalytic activity.

One problem which arises, consequently, is that of providing an improved catalyst capable of stabilizing nanometric particles of active phases under conditions similar to those encountered in the steam reforming of methane, in order to improve the performance levels thereof.

The capacity to stabilize nanometric particles becomes most meaningful in the use of noble metals, the prices of which necessitate their use in minimal mass for a maximum developed surface.

One solution of the invention is a catalyst comprising:

a) a ceramic catalyst support comprising an arrangement of crystallites of the same size, same isodiametric morphology, and same chemical composition or substantially the same size, same isodiametric morphology, and same chemical composition, in which each crystallite is in point or quasi point contact with its surrounding crystallites, and

b) at least one active phase comprising metal particles exhibiting chemical interactions with said ceramic catalyst support and mechanical anchoring in said ceramic catalyst support such that the coalescence and the mobility of each particle is limited to a maximum volume corresponding to that of one crystallite in said ceramic catalyst support.

A crystallite in the context of the present invention is a domain of material having the same structure as a monocrystal.

Where appropriate, the catalyst according to the invention may feature one or more of the following characteristics:

the chemical interaction is selected from electronic interactions and/or epitaxial interactions and/or partial encapsulation interactions;

said arrangement of the ceramic catalyst support is in spinel phase; by spinel phase is meant, for example, the phase MgAl₂O₄. However, the ceramic catalyst support may also be zirconia, zirconia stabilized with yttrium oxide, silicon carbide, silica, alumina, a silicoaluminous compound, lime, magnesia, a CaO—Al₂O₃ compound, etc.;

the metal particles are preferably selected from rhodium, platinum, palladium and/or nickel; generally speaking, the metal particles may be one or more transition metals (Fe, Co, Cu, Ni, Ag, Mo, Cr, etc., NiCo, FeNi, FeCr, etc.) or one or more transition metal oxides (CuO, ZnO, NiO, CoO, NiMoO, CuO—ZnO, FeCrO, etc.), one or more noble metals (Pt, Pd, Rh, PtRh, PdPt, etc.) or one or more transition metal oxides (Rh₂O₃, PtO, RhPtO, etc.) or mixtures of transition metals and noble metals, or mixtures of transition oxides and noble metal oxides. In certain reactions the active species may be sulfide compounds (NiS, CoMoS, NiMoS, etc.). In the case in question of the steam reforming reaction, the active phases in question will be Ni and Rh;

the crystallites have an average equivalent diameter of between 10 and 22 nm, preferably between 15 and 20 nm, and the metal particles have an average equivalent diameter of between 1 and 10 nm, preferably of less than 5 nm; by equivalent diameter is meant the greatest length of the crystallite or of the metal particle if the latter is not strictly spherical;

the arrangement of crystallites is a face-centered cubic or close-packed hexagonal stack in which each crystallite is in point or quasi point contact with not more than 12 other crystallites in a three-dimensional space, or expressed alternatively, six other crystallites in a planar space;

said catalyst comprises a substrate and a film comprising said arrangement of crystallites and the active phase;

said catalyst comprises granules comprising said arrangement of crystallites and the active phase.

The catalyst according to the invention may preferably comprise a substrate in various architectures such as cellular structures, barrels, monoliths, honeycomb structures, spheres, multiscale structured reactor-exchangers (preactors), etc. which are ceramic or metallic or ceramic-coated metallic in type, and on which the said support can be coated (washcoated).

The first advantage of the solution proposed relates to the ceramic support of the active phase or phases. This support, indeed, develops a high available specific surface area of greater than or equal to 50 m²/g, by virtue of its arrangement and the size of its nanometric particles. Moreover, the ceramic catalyst support is stable under exacting conditions of methane steam reforming; expressed alternatively, the ceramic catalyst support is stable at temperatures of between 600° C. and 900° C. and at pressures of between 20 and 30 bar in an atmosphere containing primarily the gases CH₄, H₂, CO, CO₂ and H₂O.

The particular architecture of the ceramic catalyst support directly influences the stability of the metal particles. The arrangement of the crystallites and the porosity allow mechanical anchoring of the metal particles on the surface of the support to be developed.

FIG. 1 illustrates the mechanical fixing of the metal particles by the catalyst support. First of all, it is clearly apparent that the elementary active particles will at most be the size of one support crystallite. Secondly, their movement under the combined effect of a high temperature and a water-vapor-rich atmosphere remains limited, in any case, to the potential wells represented by the space between two crystallites. The arrows show the only possible movement of the metal particles.

Finally, it is noteworthy that the mechanical fixing produced by the catalyst support limits the possible coalescence of the active particles.

On the other hand, the catalyst according to the invention maximizes the interactions between the metal and ceramic catalyst support.

The chemical bonds between the metal particles and the catalyst support are primarily covalent or ionic. They are then said to be electronic interactions. Transfer of charge may take place between the metal atoms of the active phase and the oxygen atoms or the surface cations of the support oxide.

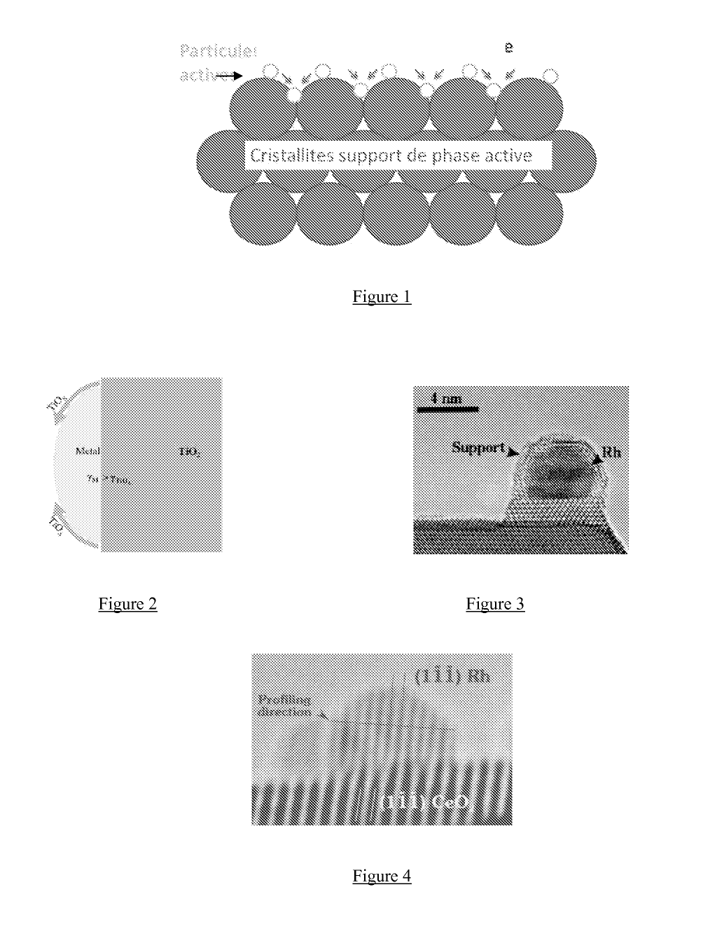

The origin of encapsulation lies in the minimization of surface energies. This phenomenon occurs when the surface energy of the metal is high and that of the oxide low. FIGS. 2 and 3 illustrate this phenomenon.

Lastly, on the basis of TEM (transmission electron microscopy) photographs, it is apparent that the crystallites are in fact monocrystals. The presence of a support composed of monocrystalline entities raises the idea of epitaxial interactions. The use of high-resolution transmission electron microscopy makes it possible to observe the metal(s)/ceramic catalyst support interfaces and thereby to draw conclusions of the existence of this type of interaction. It is noteworthy that epitaxial interaction may occur between two crystalline networks when they possess compatible lattice parameters or symmetries. FIG. 4 illustrates an epitaxial interaction.

The present invention further provides a first process for preparing a catalyst comprising a substrate and a film comprising a ceramic catalyst support comprising an arrangement of crystallites of the same size, same isodiametric morphology, and same chemical composition, or substantially the same size, same isodiametric morphology, and same chemical composition, in which each crystallite is in point or quasi point contact with its surrounding crystallites; and one or more active phases comprising metal particles exhibiting chemical interactions with said ceramic catalyst support and mechanical anchoring in said ceramic catalyst support such that the coalescence and the mobility of each particle are limited to a maximum volume corresponding to that of one crystallite in said ceramic catalyst support; and said process comprising the following steps:

a) preparation of a sol comprising magnesium nitrate, aluminum nitrate, and rhodium and/or nickel nitrate salts, a surfactant, and the solvents water, ethanol and aqueous ammonia;

b) immersion of a substrate in the sol prepared in step a);

c) drying of the sol-impregnated substrate to give a gelled composite material comprising a substrate and a gelled matrix;

d) calcining of the gelled composite material of step c) at a temperature of between 450° C. and 1100° C., preferably between 800° C. and 1000° C., more preferably still at a temperature of 900° C.; and

e) reduction of the calcined material.

A prerequisite in the context of this invention is a chemical affinity between the transition and/or noble metal(s) and the ceramic catalyst support. In the context of the steam reforming reaction of natural gas the pairings which may be cited include, for example, Ni—Al₂O₂, Ni—MgAl₂O₄, Rh—MgAl₂O₄, Rh—ZrO₂, Rh—ZrO₂ stabilized with yttrium oxide, Rh—CeO₂, Rh—CeO₂ stabilized with gadolinium oxide, etc.

The substrate employed in this first preparation process is preferably ceramic (dense alumina for example) or metallic (alloy based on NiCrO, NiFeCrO, etc.) in a variety of forms (foams, channels of multi-scale structured reactor-exchangers, barrels, powder, tablets, spheres, etc.), or metallic with a ceramic surface coating.

The present invention further provides a second process for preparing a catalyst comprising granules comprising a catalyst support comprising an arrangement of crystallites of the same size, same isodiametric morphology, and same chemical composition, or substantially the same size, same isodiametric morphology, and same chemical composition, in which each crystallite is in point or quasi point contact with its surrounding crystallites; and one or more active phases comprising metal particles exhibiting chemical interactions with said ceramic catalyst support and mechanical anchoring in said ceramic catalyst support such that the coalescence and the mobility of each particle are limited to a maximum volume corresponding to that of one crystallite in said ceramic catalyst support; and said process comprising the following steps:

a) preparation of a sol comprising aluminum nitrate, magnesium nitrate, and rhodium and/or nickel nitrate salts, a surfactant, and the solvents water, ethanol and aqueous ammonia;

b) atomization of the sol in contact with a stream of hot air, so as to evaporate the solvent and form a micron-scale powder;

c) calcining of the powder at a temperature of between 450° C. and 1100° C., preferably between 800° C. and 1000° C., more preferably still at a temperature of 900° C.; and

d) reduction of the calcined material.

The two processes for preparing a catalyst according to the invention may feature one or more of the characteristics below:

the sol prepared in step a) is aged in a ventilated oven at a temperature of between 15 and 35° C.

step d) for the “film” route and c) for the “powder” route of calcination is carried out in air and has a duration of 24 hours.

The sol prepared in the two processes for preparing a catalyst according to the invention preferably comprises four principal constituents:

Inorganic precursors: for reasons of cost limitation, we have chosen to use magnesium nitrate, aluminum nitrate, rhodium nitrate and/or nickel nitrate. The stoichiometry of these nitrates may be verified by ICP (inductively coupled plasma), before they are dissolved in osmosed water.

Surfactant, also called surface-active agent. Use may be made of a Pluronic F127 EO-PO-EO triblock copolymer. It possesses two hydrophilic blocks (EO) and a central hydrophobic block (PO).

Solvent (absolute ethanol).

NH₃.H₂O (28% by mass). The surfactant is dissolved in an ammoniacal solution, forming hydrogen bonds between the hydrophilic blocks and the inorganic species.

An example of molar ratios of these various constituents is given in the table below (Table 1):

| | |
|---|---|
| n_{H2O}/nₙᵢₜᵣₐₜₑ | 111 |
| n_{EtOH}/nₙᵢₜᵣₐₜₑ | 38 |
| n_{F127}/nₙᵢₜᵣₐₜₑ | 6.7 × 10⁻³ |
| n_{F127}/n_{H2O} | 6.0 × 10⁻⁶ |

The process for preparing the sol is described in FIG. 5.

In the paragraph below, the amounts in brackets correspond to a single example.

The first step is to dissolve the surfactant (0.9 g) in absolute ethanol (23 ml) and in an ammoniacal solution (4.5 ml). The mixture is subsequently heated at reflux for 1 hour. The solution of aluminum nitrate, magnesium nitrate, and rhodium nitrate that has been prepared beforehand (20 ml) is then added dropwise to the mixture. The whole mixture is heated at reflux for 1 hour and then cooled to the ambient temperature. The sol thus synthesized is aged in a ventilated oven with a precisely controlled ambient temperature (20° C.)

In the case of the first process for preparing a catalyst according to the invention, the immersion involves dipping a ceramic substrate or metallic substrate or metallic substrate surface-coated with ceramic in the sol and withdrawing it at a constant rate. The substrates used in the context of our study are alumina plaques sintered at 1700° C. for 1 hour 30 minutes in air (relative density of the substrates=97% relative to the theoretical density).

In the course of the withdrawal of the substrate, the movement of the substrate entrains the liquid, forming a surface layer. This layer divides into two, with the inner part moving with the substrate, while the outer part falls back into the vessel. Progressive evaporation of the solvent leads to the formation of a film on the surface of the substrate.

The thickness of the resultant coating can be estimated from the viscosity of the sol and from the drawing rate (equation 1):

e ∞ κ v^{2/3}

where κ is a coating constant dependent on the viscosity and on the density of the sol, and on the liquid-vapor surface tension. v is the drawing rate.

Accordingly, the greater the drawing rate, the greater the thickness of the coating.

The immersed substrates are subsequently oven-treated at between 30° C. and 70° C. for a number of hours. A gel is then formed. Calcining of the substrates in air removes the nitrates but also breaks down the surfactant and thus liberates the porosity.

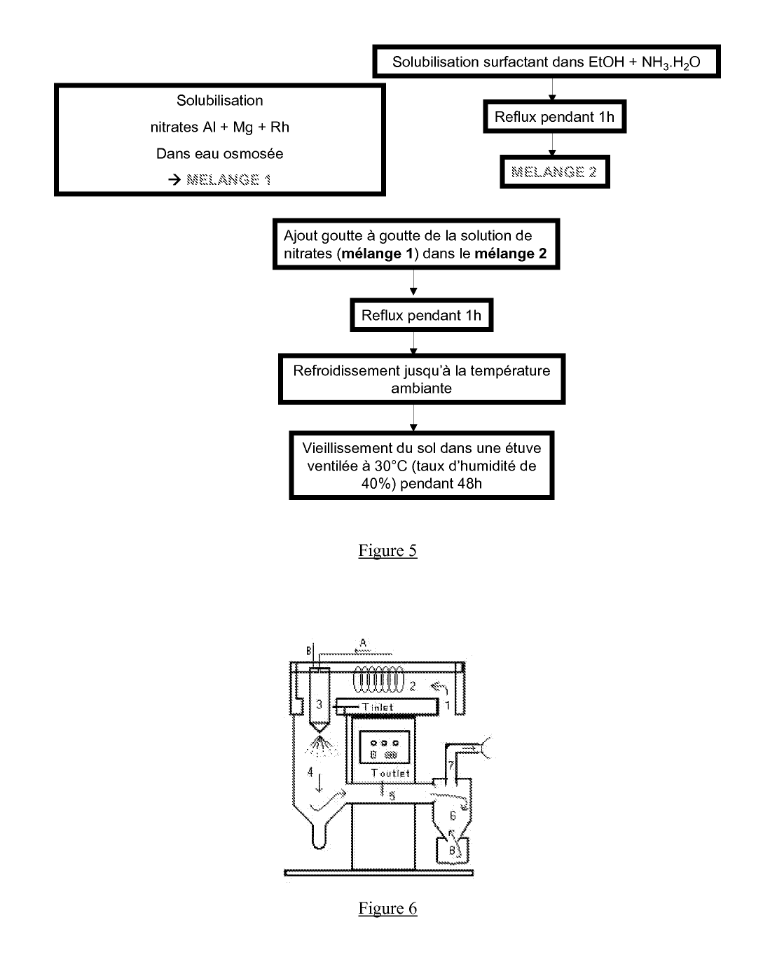

In the case of the second process for preparing a catalyst according to the invention, the atomization technique converts a sol into a solid, dry form (micron-scale powder) through the use of a hot intermediate (FIG. 6).

The principle lies in the spraying of the sol 3 into fine droplets in a chamber 4 in contact with a stream of hot air 2 in order to evaporate the solvent. The resulting powder is carried by the heat flow 5 to a cyclone 6 which will separate the air 7 from the powder 8.

The apparatus which may be used in the context of the present invention is a commercial Büchi 190 Mini Spray Dryer model.

The micron-scale powder recovered at the end of atomization is dried in an oven at 70° C. and then calcined.

Therefore, in the two processes, the precursors of the oxide support, in other words the magnesium nitrate and aluminum nitrate salts, are partially hydrolyzed (equation 2). The evaporation of the solvents (ethanol and water) then allows the sol to crosslink as a gel around the micelles of surfactant by the formation of bonds between the hydroxyl groups of a salt and the metal of another salt (equations 3 and 4).

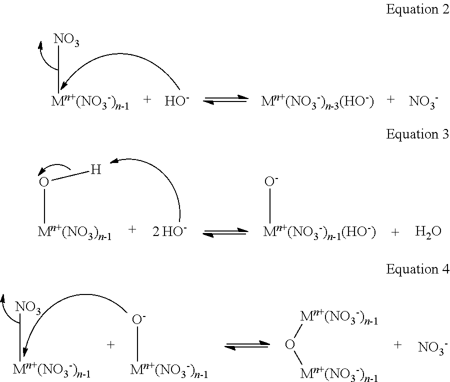

Controlling these reactions associated with the electrostatic interactions between the inorganic precursors and the surfactant molecules allows cooperative assembly of the organic and inorganic phases, thereby producing micellar aggregates of surfactants of controlled size within an inorganic matrix.

The reason is that the nonionic surfactants used are copolymers which posses two moieties having different polarities: a hydrophobic body, and hydrophilic ends. These copolymers form part of the class of block copolymers consisting of polyalkyl oxide chains. An example is the copolymer (EO)n-(PO)m-(EO)n, consisting of a concatenation of polyethylene oxide (EO), which is hydrophilic at the ends and, in its central part, polypropylene oxide (PO), which is hydrophobic. The chains of polymers remain dispersed in solution when the concentration is less than the critical micelle concentration (CMC). The CMC is defined as being the limiting concentration beyond which there is a phenomenon of self-assembly of the surfactant molecules in the solution. Beyond this concentration, the chains of the surfactant tend to assemble as a result of hydrophilic/hydrophobic affinity. Accordingly, the hydrophobic bodies assemble and form spherical micelles. The ends of the polymer chains are pushed toward the outside of the micelles, and associate during the evaporation of the volatile solvent (ethanol) with the ionic species in solution, which also have hydrophilic affinities.

This phenomenon of self-assembly takes place during step b) for the “film” route and step c) for the “powder” drying route in the synthesis processes according to the invention.

Calcining at 1000° C. destroys the mesostructuring of the coating which was present at 500° C. (conventional calcining). Crystallization of the spinel phase brings about a local disorganization in the porosity. The result, nevertheless, is a catalyst support according to the invention, in other words a ceramic catalyst support in the form of an ultra-finely divided and highly porous coating or powder, with quasi spherical ceramic catalyst support particles in contact with one another.

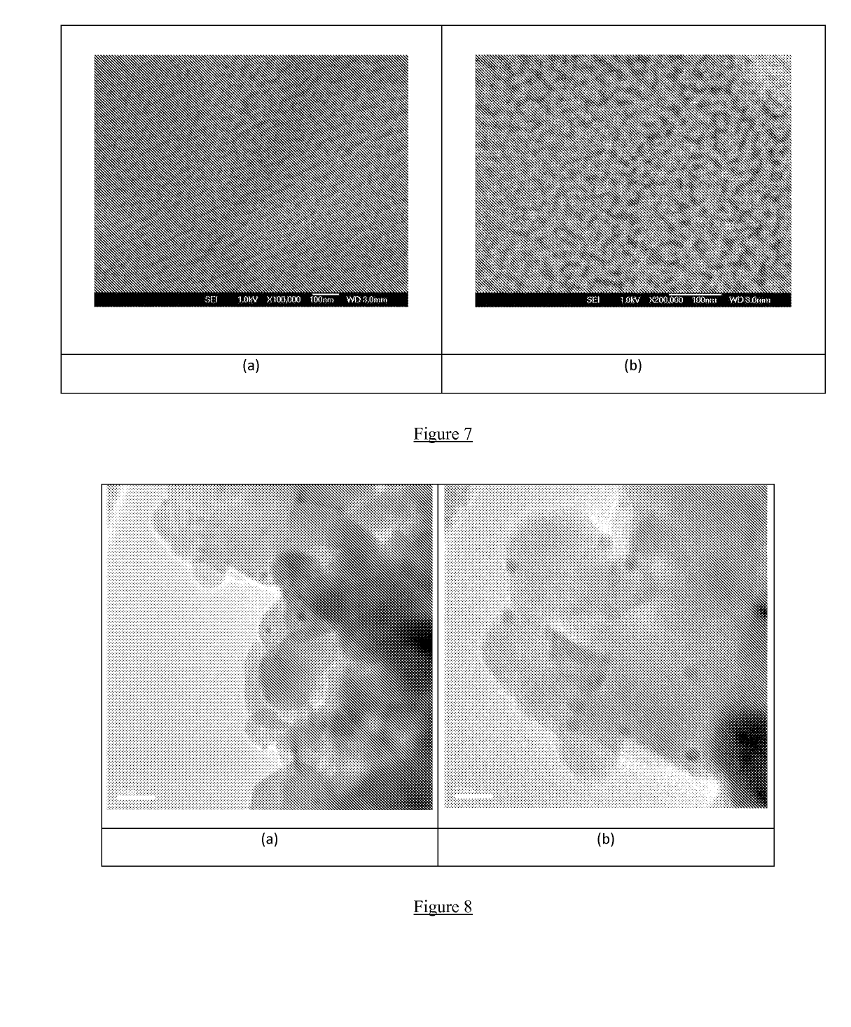

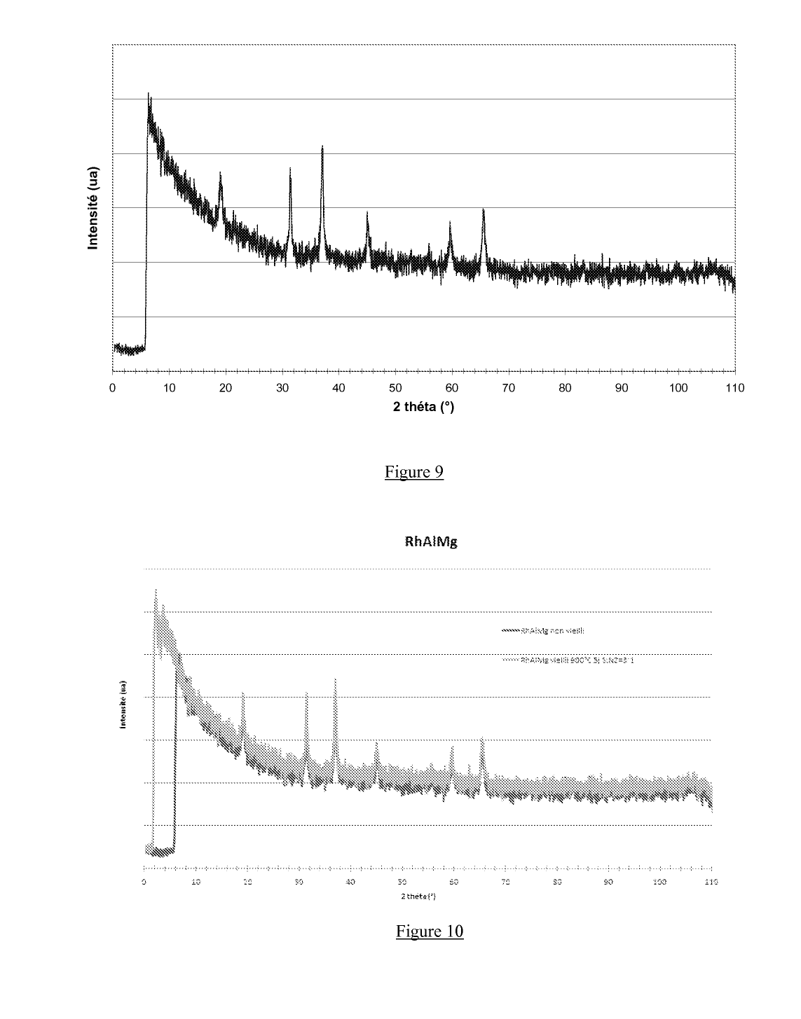

By way of example, in the context of the first process for preparing a catalyst according to the invention, the substrate is calcined in air at 1000° C. for 4 hours and then reduced under Ar—H2 (3% by volume) at 1000° C. for 1 hour. The microstructure of the coating is monitored in a first phase by scanning electron microscopy (FIG. 7).

The coating, which is highly porous and ultra-finely divided, is composed of quasi spherical spinel particles in contact with one another. These particles, with a size of around 20 nanometers, exhibit a very narrow particle size distribution. The particles of Rh are difficult to visualize by this analytical technique since they are small (size less than 10 nm). This is why transmission electron microscopy was required in order to visualize them (FIG. 8). The particles of Rh have a size of the order of 2 nm and are localized around the spinel particles.

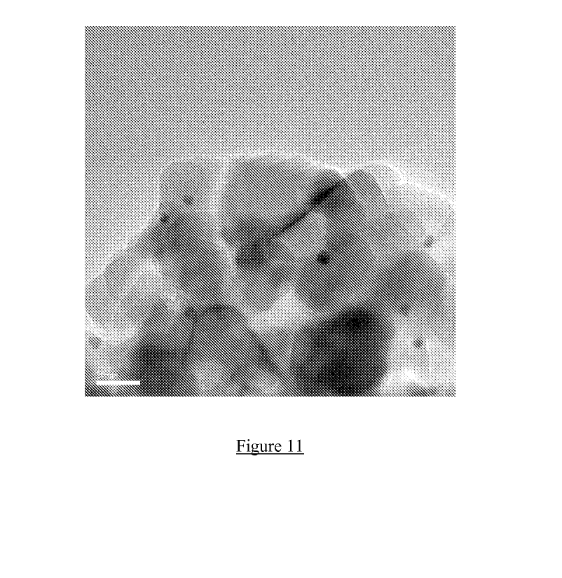

The average size of the spinel particles, determined by small-angle XR diffraction, is 20 nm (FIG. 9).

Small-angle X-ray diffraction (2θ angle values of between 0.5 and 6°): this technique allows the size of the crystallites in the catalyst support to be ascertained. The diffractometer used in this study, based on a Debye-Scherrer geometry, is equipped with a curved localization detector (Inel CPS 120) in the center of which the sample is positioned. The sample is a monocrystalline sapphire substrate to which the sol has been applied by immersion/drawing. The Scherrer formula relates the half-height width of the diffraction peaks to the size of the crystallites (equation 5).

$$D = 0.9 \times \frac{λ}{β cos θ} \qquad Equation 5$$

D corresponds to the size of the crystallites (nm)

λ is the wavelength of the Kα ray of Cu (1.5406 Å)

β corresponds to the half-height width of the ray (in rad)

θ corresponds to the diffraction angle.

Still by way of example, in the context of the second process for preparing a catalyst according to the invention, the atomization of the RhAlMg sol, followed by a calcining of powder in air at 1000° C. for 4 hours, produces spherical droplets with a diameter of less than 5 μm and preferably within a range between 100 nm and 2 μm. The droplets are porous and composed of nanometric support particles with a diameter of approximately 20 nm.

The thin films obtained by immersing the sol onto a substrate, and also the powders obtained by atomizing the sol, were aged under hydrothermal conditions, specifically at a temperature of 900° C. for 100 hours under an atmosphere rich in water vapor and nitrogen (the molar ratio of water vapor to nitrogen is 3).

The ultra-finely divided microstructure of the coatings calcined at 1000° C. changes little in the course of the hydrothermal aging. The very great homogeneity of size, of morphology and of chemical composition, and also the ultra-fine division (that is, the limited number of contacts between particles), considerably limit the local gradients in chemical potential that constitute the driving force for the migration of the species responsible for sintering. The conservation of the size of the particles was confirmed by the results of small-angle XR diffraction (FIG. 10). Indeed, the size of the crystallites measured by this technique is 20 nm after aging.

Furthermore, the particles of Rh exhibit little enlargement after hydrothermal aging. Their size does not exceed 5 nm (FIG. 11). This is confirmed by the formation of an Rh spinel solid solution (determined by TPR—temperature programmed reduction—analyses) which allows chemical fixing of the particles of Rh on the support.

It should be noted that a third process for preparing the catalyst according to the invention could be employed. In this third process, there would be a first step of preparation of the ceramic support, a second step of impregnation of the support with a precursor solution of rhodium or nickel, and a third step of calcining.

We will now study the stability of a catalyst according to the invention over time.

The AlMgRh catalyst according to the invention was aged in an SMR reactor (SMR=steam methane reformer) for 20 days. The operating conditions of the reactor are indicated in table 1.

TABLE 1

| | Steam/carbon | |
|---|---|---|
| Duration of aging | ratio | Pressure |
| 20 days | 1.9 molar | 20 bar |

One sample was placed in the top of the reactor and was therefore subject to a temperature of the order of 650° C. and the other sample was placed in the bottom of the reactor at a temperature of the order of 820° C.

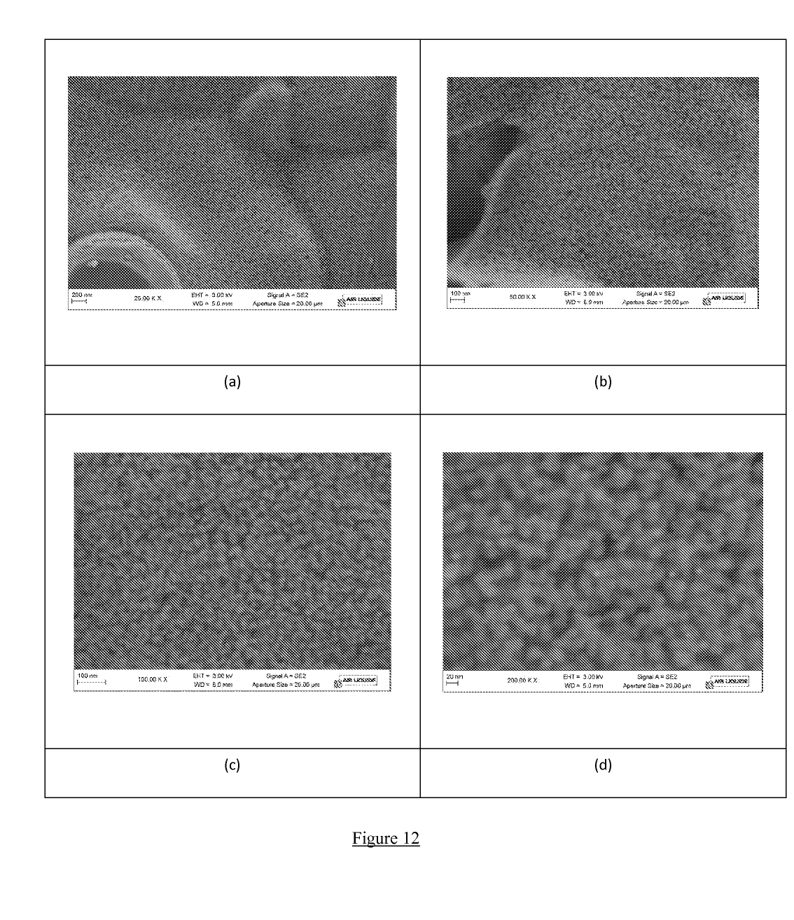

The microstructure of the catalysts leaving the aging process was observed by scanning electron microscopy. Since the specimens were similar at the top and bottom of the reactor, we will present the characterizations of the catalyst placed at the bottom of the reactor, at the highest temperatures (FIG. 12: FEG-SEM micrographs at different enlargements of the RhAlMg catalyst aged in an SMR reactor).

The ultra-finely divided spinel-phase support is conserved after aging, and the enlargement of the spinel particles is limited.

As far as the metal particles are concerned, they seem to be extremely small, since even with a magnification of ×200 000, they are barely visible.

The advantage of developing an ultra-finely divided support in order to promote anchoring of active phases is broadly demonstrated in these micrographs.

Consequently, it will be possible with preference to use the catalyst according to the invention for the steam reforming of methane.

In the context of this study, the reaction relates to the steam reforming of natural gas. This invention can be extended to diverse applications in heterogeneous catalysis involving an adaptation of one or more active phases to the desired catalytic reaction (removal of automobile pollution, chemical reactions, petrochemical reactions, environmental reactions, etc.) on an ultra-finely divided, spinel-based, ceramic catalyst support.

1-12. (canceled)

13. A catalyst comprising:
a) a ceramic catalyst support comprising an arrangement of crystallites of the same size, same isodiametric morphology, and same chemical composition or substantially the same size, same isodiametric morphology, and same chemical composition, in which each crystallite is in point or quasi point contact with its surrounding crystallites, and
b) at least one active phase comprising metal particles exhibiting chemical interactions with said ceramic catalyst support and mechanical anchoring in said catalyst support such that the coalescence and the mobility of each particle is limited to a maximum volume corresponding to that of one crystallite in said catalyst support.

14. The catalyst of claim 13, wherein the chemical interaction is selected from electronic interactions and/or epitaxial interactions and/or partial encapsulation interactions.

15. The catalyst of claim 13, wherein said arrangement is in spinel phase.

16. The catalyst of claim 13, wherein the metal particles are selected from rhodium, platinum, palladium and/or nickel.

17. The catalyst of claim 13, wherein the crystallites have an average equivalent diameter of between 10 and 22 nm, preferably between 15 and 20 nm, and the metal particles have an average equivalent diameter of between 1 and 10 nm, preferably of less than 5 nm.

18. The catalyst of claim 13, wherein the arrangement of crystallites is a face-centered cubic or close-packed hexagonal stack in which each crystallite is in point or quasi point contact with not more than 12 other crystallites in a three-dimensional space.

19. The catalyst of claim 13, wherein said catalyst comprises a substrate and a film comprising said arrangement of crystallites and the active phase.

20. The catalyst of claim 13, wherein said catalyst comprises granules comprising said arrangement of crystallites and the active phase.

21. The process for preparing a catalyst of claim 19, comprising the following steps:
a) preparation of a sol comprising magnesium nitrate, aluminum nitrate, and rhodium and/or nickel nitrate salts, a surfactant, and the solvents water, ethanol and aqueous ammonia;
b) immersion of a substrate in the sol prepared in step a);
c) drying of the sol-impregnated substrate to give a gelled composite material comprising a substrate and a gelled matrix;
d) calcining of the gelled composite material of step c) at a temperature of between 450° C. and 1100° C., preferably between 800° C. and 1000° C., more preferably still at a temperature of 900° C.; and
e) reduction of the calcined material.

22. The preparation process of claim 21, wherein the substrate is a ceramic or metallic substrate or a metallic substrate surface-coated with a ceramic.

23. The process for preparing a catalyst of claim 20, comprising the following steps:
a) preparation of a sol comprising aluminum nitrate, magnesium nitrate, and rhodium and/or nickel nitrate salts, a surfactant, and the solvents water, ethanol and aqueous ammonia;
b) atomization of the sol in contact with a stream of hot air, so as to evaporate the solvent and form a micron-scale powder;
c) calcining of the powder at a temperature of between 450° C. and 1100° C., preferably between 800° C. and 1000° C., more preferably still at a temperature of 900° C.; and
d) reduction of the calcined material.

24. The use of a catalyst of claim 13 for the steam reforming of methane.
